(19) United States
(12) Patent Application Publication
(10) Pub. No.: US 2008/0127230 A1
(43) Pub. Date: May 29, 2008

(54) Method and system for transmitting data

(75) Inventors: Periklis Moutzouros, Morton Grove, IL (US); Dennis Jinsi Wang, Aurora, IL (US); James Alan Holt, Issaquah, WA (US)

Correspondence Address: Daniel H. Golub, 1701 Market Street, Philadelphia, PA, 19103, US

(73) Assignee: Townsend Analytics, Ltd., Chicago, IL (US)

(21) Appl. No.: 11/605,871

(22) Filed: Nov. 29, 2006

(51) Int. Cl. G06F 9/46; G06F 15/16

(52) U.S. Cl. 719/328; 709/203

(57) ABSTRACT

A data transmission system and method. The data is associated with an application and the application is used in connection with accessing a business process. The business process is associated with an activity time period, commencing with an opening time and ending with a closing time. One or more requests for data associated with the application are received. The requested data comprises data that is not refreshed during the activity time period. The request comprises a command embedded in a hyper text transfer protocol request. The request is parsed. A data repository is queried for data responsive to the request. A result set of data is generated in response to the query. The data in the result set is translated to a binary format. The translated data is transmitted over a communication channel using hyper text transfer protocol.

### FIELD OF THE INVENTION

The present invention relates to transmitting data from a server to a client in connection with use of an application.

### BACKGROUND OF THE INVENTION

Many client applications involve making requests for data from servers where the substance of the data does not change, or does not change frequently, over the course of a given time period (e.g., a day), also referred to herein as static data. For example, in the context of an electronic quoting and trading platform, data regarding the 52 week high/low for a given stock does not change over the course of a trading day (instead, it is updated during the time period in which the market is closed), as opposed to the price at which a stock is being traded, which fluctuates frequently over the time period in which the market is open. In addition, in connection with the operation of electronic quoting and trading platforms, and indeed in other contexts, large volumes of data are continually being transmitted between clients and servers. Transmitting static data over the same channels as changing data (e.g., quote and trade data) slows the transmission of all data relating to these applications between clients and servers, which is a highly undesirable result. Thus, there is a need for a system that delivers to client applications static data as needed, without impeding the delivery of other data that changes on a more regular basis.

### SUMMARY OF THE INVENTION

The present invention is directed to a method, system and computer-readable medium for transmitting data. The data is associated with an application and the application is used in connection with accessing a business process. The business process is associated with an activity time period, commencing with an opening time and ending with a closing time. One or more requests for data associated with the application are received. The requested data comprises data that is not refreshed during the activity time period. The request comprises a command embedded in a hyper text transfer protocol request. The request is parsed. A data repository is queried for data responsive to the request. A result set of data is generated in response to the query. The data in the result set is translated to a binary format. The translated data is transmitted over a communication channel using hyper text transfer protocol.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1A is an exemplary system diagram that may be used for implementing the present invention;

FIG. 1B is an alternate exemplary system diagram that may be used for implementing the present invention; and

FIG. 2 is a flow diagram illustrating steps of a method of the present invention.

### DETAILED DESCRIPTION OF THE PREFERRED EMBODIMENTS

In one solution to the problem, blocks of data in binary format are sent to a client using hyper text transfer protocol after querying a server for the requested data. A permissioned bridge/translation engine is implemented between the client and data persisted inside a data repository that requires conversion, e.g., from XML, to binary format. By providing the data in binary format, the bloat of, e.g., XML, is removed and security can be added, thereby providing a means of authentication and authorization.

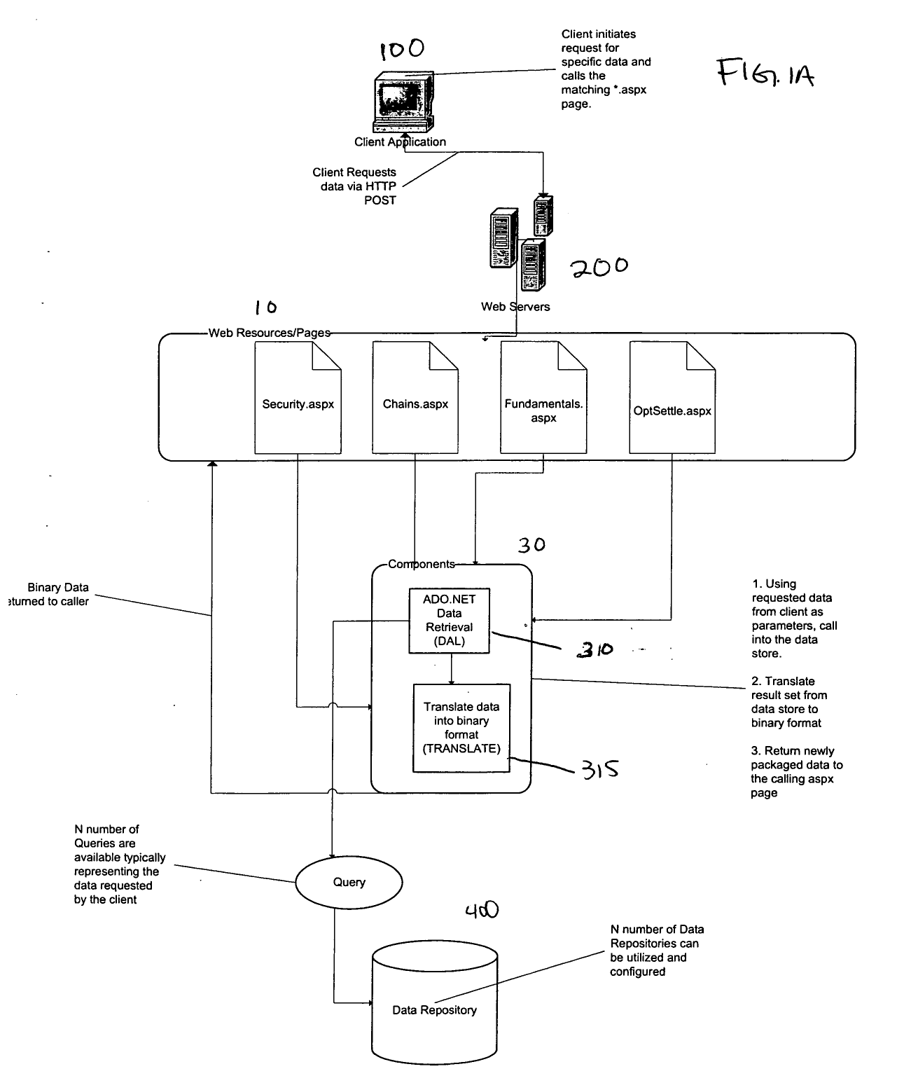

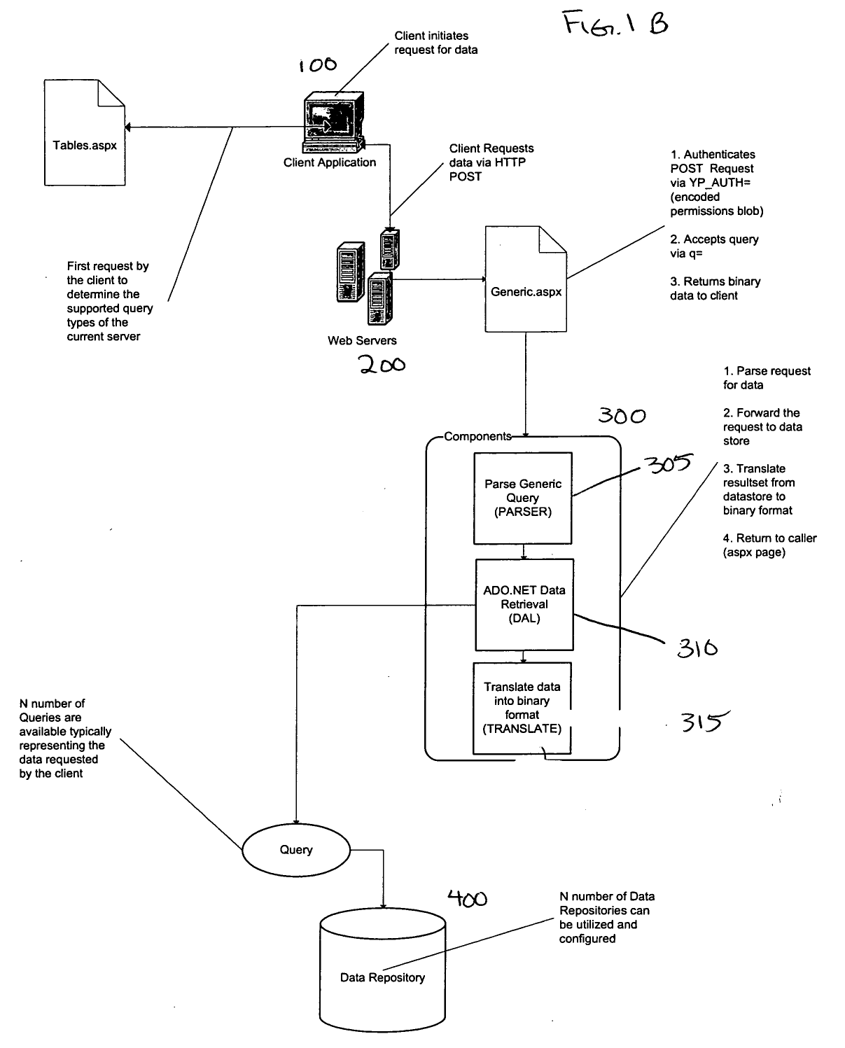

One embodiment is described with reference to FIG. 1A. On start up, a request is initiated by the client 100. The request is for specific data and calls the corresponding page 10 (i.e., *.aspx page). For example, if securities data is sought, the page called is security.aspx. The pages 10 identified in FIG. 1A are exemplary only; other pages corresponding to other data types can be used in accordance with the present invention. Each time the application calls for a new type of data to be exposed, a separate web page is created to handle requests for such data; each web page contains the same logic. Using the data requested from client 100 as a parameter, a call into the data repository 400 is made by engine 30. Data access layer 310 interfaces with data repository 400. The result set is returned to engine 30 and translated to binary format by translator 315. The data blocks are returned to the client 100 via the calling .aspx page.

An alternate embodiment is described with reference to FIG. 1B. On start up, a first request is made by the client 100, using tables.aspx in this example, to determine the supported query types of the server 200. After learning the supported query types, the client 100 initiates a request for data. This request takes the form of a generic.aspx page, in this example, and comprises an HTTP post request to server 200. In the preferred embodiment, the request includes an encoded permissions blob that allows for authentication. Engine 300 parses the request using parser 305 to determine the data type that is the subject of the request and forwards the request to the data repository 400. Data access layer 310 interfaces with data repository 400. A number N of queries are available, which typically represents the data requested by the client 100. A corresponding number N of data repositories 400 can be utilized and configured. The result set is returned to engine 300 and translated to binary format by translator 315. The data blocks are returned to the client 100.

The embodiment described with reference to FIG. 1B eliminates the need to have a separate web page for each type of data requested. Instead, a proxy is sent, providing instructions of how to identify the data sought (i.e., instead of identifying the specific symbols and fields desired). In this way, many different data types can be supported without having to alter an application on client 100.

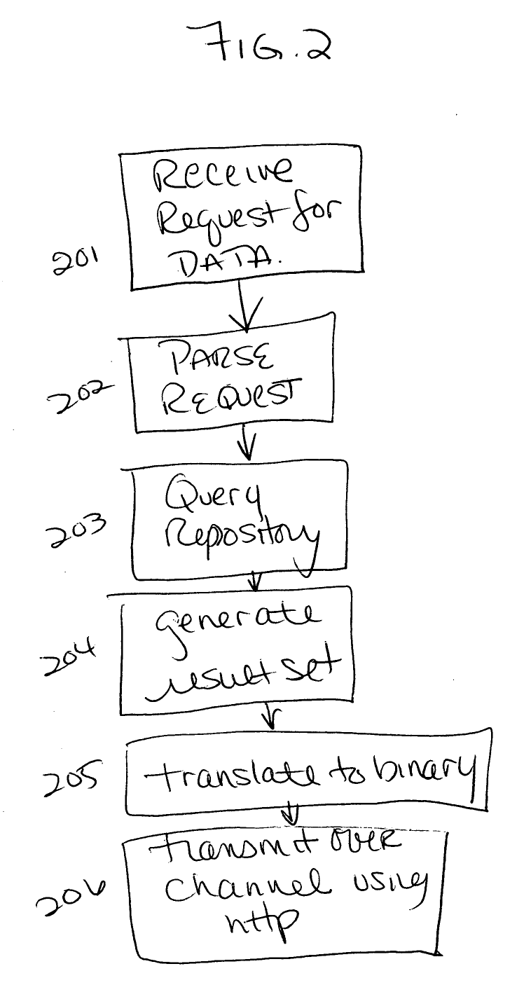

With reference to FIG. 2, a flow diagram is shown. One or more requests for data associated with the application are received in step 201. The requested data comprises data that is not refreshed during the activity time period. The request comprises a command embedded in a hyper text transfer protocol request. The request is parsed in step 202. A data repository is queried for data responsive to the request in step 203. A result set of data is generated in response to the query in step 204. The data in the result set is translated to a binary format in step 205. The translated data is transmitted over a communication channel using hyper text transfer protocol in step 206.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. A method for transmitting data, wherein the data is associated with an application, and the application is used in connection with accessing a business process, wherein the business process is associated with an activity time period, commencing with an opening time and ending with a closing time, the method comprising the steps of:
(A) receiving one or more requests for data associated with the application, wherein the requested data comprises data that is not refreshed during the activity time period, and wherein the request comprises a command embedded in a hyper text transfer protocol request;
(B) parsing the request;
(C) querying a data repository for data responsive to the request;
(D) generating a result set of data in response to the query;
(E) translating the data in the result set to a binary format; and
(F) transmitting the translated data over a communication channel using hyper text transfer protocol.

2. The method of claim 1 wherein the request comprises a request identifying a specific type of data.

3. The method of claim 1 wherein the request comprises a query comprising a set of instructions describing how the data repository should be queried to identify the data responsive to the request.

4. The method of claim 1 wherein the business process is associated with securities trading and the activity time period comprises a trading day.

5. A method for transmitting data, wherein the data is associated with an application, and the application is used in connection with accessing a business process, wherein the business process is associated with an activity time period, commencing with an opening time and ending with a closing time, the method comprising the steps of:
(A) transmitting one or more requests for data associated with the application, wherein the requested data comprises data that is not refreshed during the activity time period, and wherein the request comprises a command embedded in a hyper text transfer protocol request;
wherein the request is parsed; a data repository is queried for data responsive to the request; a result set of data is generated in response to the query; and the data in the result set is translated to a binary format; and
(B) receiving the translated data over a communication channel using hyper text transfer protocol.

6. The method of claim 5 wherein the request comprises a request identifying a specific type of data.

7. The method of claim 5 wherein the request comprises a query comprising a set of instructions describing how the data repository should be queried to identify the data responsive to the request.

8. The method of claim 5 wherein the business process is associated with securities trading and the activity time period comprises a trading day.

9. A system for transmitting data, wherein the data is associated with an application, and the application is used in connection with accessing a business process, wherein the business process is associated with an activity time period, commencing with an opening time and ending with a closing time, the system comprising:
one or more server components that receive one or more requests for data associated with the application, wherein the requested data comprises data that is not refreshed during the activity time period, and wherein the request comprises a command embedded in a hyper text transfer protocol request;
one or more parsing components that parse the request;
one or more data repositories that are queried for data responsive to the request and generate a result set of data in response to the query; and
one or more translator components that translate the data in the result set to a binary format;
the one or more server components transmitting the translated data over a communication channel using hyper text transfer protocol.

10. The system of claim 9 wherein the request comprises a request identifying a specific type of data.

11. The system of claim 9 wherein the request comprises a query comprising a set of instructions describing how the data repository should be queried to identify the data responsive to the request.

12. The system of claim 9 wherein the business process is associated with securities trading and the activity time period comprises a trading day.

13. A computer-readable medium comprising instructions which, when executed by a processor, perform a method for transmitting data, wherein the data is associated with an application, and the application is used in connection with accessing a business process, wherein the business process is associated with an activity time period, commencing with an opening time and ending with a closing time, wherein one or more requests for data associated with the application are received, wherein the requested data comprises data that is not refreshed during the activity time period, and wherein the request comprises a command embedded in a hyper text transfer protocol request, the method comprising the steps of:
(A) parsing the request;
(B) querying a data repository for data responsive to the request;
(C) generating a result set of data in response to the query;
(D) translating the data in the result set to a binary format; and
(E) transmitting the translated data over a communication channel using hyper text transfer protocol.

14. The computer-readable medium of claim 13 wherein the request comprises a request identifying a specific type of data.

15. The computer-readable medium of claim 13 wherein the request comprises a query comprising a set of instructions describing how the data repository should be queried to identify the data responsive to the request.

16. The computer-readable medium of claim 13 wherein the business process is associated with securities trading and the activity time period comprises a trading day.
